(19) United States
(12) Patent Application Publication
(10) Pub. No.: US 2020/0380595 A1
(43) Pub. Date: Dec. 3, 2020

(54) METHOD AND SYSTEM FOR DISTRIBUTING DRIVING RESOURCES

(71) Applicant: GM GLOBAL TECHNOLOGY OPERATIONS LLC, Detroit, MI (US)

(72) Inventor: Marcus J Huber, Saline, MI (US)

(21) Appl. No.: 16/426,040

(22) Filed: May 30, 2019

(51) Int. Cl. G06Q 30/08; G06Q 30/02; G06Q 50/30; G08G 1/01; G08G 1/09; G08G 1/14

(52) U.S. Cl. CPC G06Q 30/08; G06Q 30/0205; G06Q 50/30; G06Q 2240/00; G08G 1/091; G08G 1/143; G08G 1/0145

(57) ABSTRACT

A method and system that distribute driving resources are provided. The method includes: receiving driving and situation resource information of a host vehicle, comparing the received driving and situation resource information with occupant preference information to determine whether there is a deficiency of driving resources, a surplus of driving resources, or that the driving and situation resources meet the occupant preferences, offering a surplus resource to target vehicles if it is determined there is a surplus of driving resources, and making an offer for a resource corresponding to deficient resources of the host vehicle if it is determined there is a deficiency of driving resources.

### INTRODUCTION

Apparatuses and methods consistent with exemplary embodiments relate to distributing resources. More particularly, apparatuses and methods consistent with exemplary embodiments relate to allowing drivers and occupants of vehicles procure driving resources from other drivers or entities.

### SUMMARY

One or more exemplary embodiments provide a method and an apparatus that distribute driving resources. More particularly, one or more exemplary embodiments provide a method and an apparatus that distribute driving resources using a bidding system.

According to an aspect of an exemplary embodiment, a method for distributing driving resources is provided. The method includes receiving driving and situation resource information of a host vehicle, comparing the received driving and situation resource information with occupant preference information to determine whether there is a deficiency of driving resources, a surplus of driving resources, or that the driving and situation resources meet the occupant preferences, offering a surplus resource to target vehicles if it is determined there is a surplus of driving resources, and making an offer for a resource corresponding to deficient resources of the host vehicle if it is determined there is a deficiency of driving resources.

The driving and situation resource information may include one or more from among a route of the host vehicle, a lane of travel of the host vehicle, parking spots available to the host vehicle, a driving configuration of the host vehicle, an energy level of the host vehicle, a speed of the host vehicle, traffic light status, traffic light timing.

The occupant preference information may be that of a driver or an occupant in an autonomous vehicle, and the occupant preference information may include one or more from among a preferred route to a destination of the host vehicle, a preferred lane to be traveled on by the host vehicle, a preferred, driving configuration of the host vehicle, a preferred parking spot for the host vehicle, a required energy level of the host vehicle, and a preferred speed for the host vehicle.

The offering the surplus resource to the target vehicles may include broadcasting a message including an offer to provide one or more from among a route of the host vehicle, a lane of travel of the host vehicle, parking spots available to the host vehicle, a driving configuration of the host vehicle, an energy level of the host vehicle, a speed of the host vehicle, and a price.

The offer may include an auction and the method may further include receiving bids for the offer from the target vehicles, selecting a bid from among the received bids, and transferring the offered surplus resource to a target vehicle corresponding to the selected bid from among the target vehicles.

The transferring the surplus resource may include controlling the host vehicle to provide the offered surplus resource to the target vehicle corresponding to the selected bid from among the target vehicles.

The making an offer for the resource may include determining whether the resource is being offered by analyzing communication messages from target vehicles or an infrastructure device, transmitting a bid for an offered resource if it is determined that the resource is being offered, and transmitting a bid requesting the resource if it is determined that the resource is not being offered.

The method may further include determining if the bid for the resource is accepted, and controlling the vehicle to accept the transfer of the resource if it is determined that the bid is accepted.

The controlling the vehicle may include one or more from among changing the route of the host vehicle to a route corresponding to the transferred resource, changing the lane of travel of the host vehicle to a lane corresponding to the transferred resource, moving the host vehicle to a parking spot corresponding to the transferred resource, aligning the host vehicle with target vehicles in a driving configuration corresponding to the transferred resource, recharging the host vehicle with energy corresponding to the transferred resource, and increasing the speed of the host vehicle in manner corresponding to the transferred resource.

The bid may include credits allocated to the host vehicle based on one or more from among resource sharing and driving habits.

According to an aspect of another exemplary embodiment, a system that distributes driving resources is provided. The system includes at least one memory including computer executable instructions; and at least one processor configured to read and execute the computer executable instructions. The computer executable instructions cause the at least one processor to receive driving and situation resource information of a host vehicle, compare the received driving and situation resource information with occupant preference information to determine whether there is a deficiency of driving resources, a surplus of driving resources, or that the driving and situation resources meet the occupant preferences, offer a surplus resource to target vehicles if it is determined there is a surplus of driving resources, and make an offer for a resource corresponding to deficient resources of the host vehicle if it is determined there is a deficiency of driving resources.

The driving and situation resource information includes one or more from among a route of the host vehicle, a lane of travel of the host vehicle, parking spots available to the host vehicle, a driving configuration of the host vehicle, an energy level of the host vehicle, and a speed of the host vehicle.

The occupant preference information is that of a driver or an occupant in an autonomous vehicle, and the occupant preference information includes one or more from among a preferred route to a destination of the host vehicle, a preferred lane to be traveled on by the host vehicle, a preferred, driving configuration of the host vehicle, a preferred parking spot for the host vehicle, a required energy level of the host vehicle, and a preferred speed for the host vehicle.

The computer executable instructions may further cause the at least one processor to offer the surplus resource to the target vehicles by broadcasting a message including an offer to provide one or more from among a route of the host vehicle, a lane of travel of the host vehicle, parking spots available to the host vehicle, a driving configuration of the host vehicle, an energy level of the host vehicle, a speed of the host vehicle, and a price.

The offer may include an auction, and the computer executable instructions may further cause the at least one processor to bids for the offer from the target vehicles, select a bid from among the received bids, and transfer the offered surplus resource to a target vehicle corresponding to the selected bid from among the target vehicles.

The computer executable instructions may further cause the at least one processor to transfer the surplus resource by controlling the host vehicle to provide the offered surplus resource to the target vehicle corresponding to the selected bid from among the target vehicles

The computer executable instructions may further cause the at least one processor to make an offer for the resource by determining whether the resource is being offered by analyzing communication messages from target vehicles or an infrastructure device, transmitting a bid for an offered resource if it is determined that the resource is being offered, and transmitting a bid requesting the resource if it is determined that the resource is not being offered.

The computer executable instructions may further cause the at least one processor to determine if the bid for the resource is accepted, and control the vehicle to accept the transfer of the resource if it is determined that the bid is accepted.

The computer executable instructions may further cause the at least one processor to control the vehicle by performing one or more from among changing the route of the host vehicle to a lane corresponding to the transferred resource, changing the lane of travel of the host vehicle to a lane corresponding to the transferred resource, moving the host vehicle to a parking spot corresponding to the transferred resource, aligning the host vehicle with target vehicles in a driving configuration corresponding to the transferred resource, recharging the host vehicle with energy corresponding to the transferred resource, and increasing the speed of the host vehicle in manner corresponding to the transferred resource.

The bid may include credits allocated to the host vehicle based on one or more from among resource sharing and driving habits.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of a system that distributes driving resources according to an exemplary embodiment;

FIGS. 2A-2C show flowcharts for a method that distributes driving resources according to an exemplary embodiment; and

FIG. 3 shows an illustration of vehicle communicating to distribute driving resources according to an aspect of an exemplary embodiment.

### DETAILED DESCRIPTION

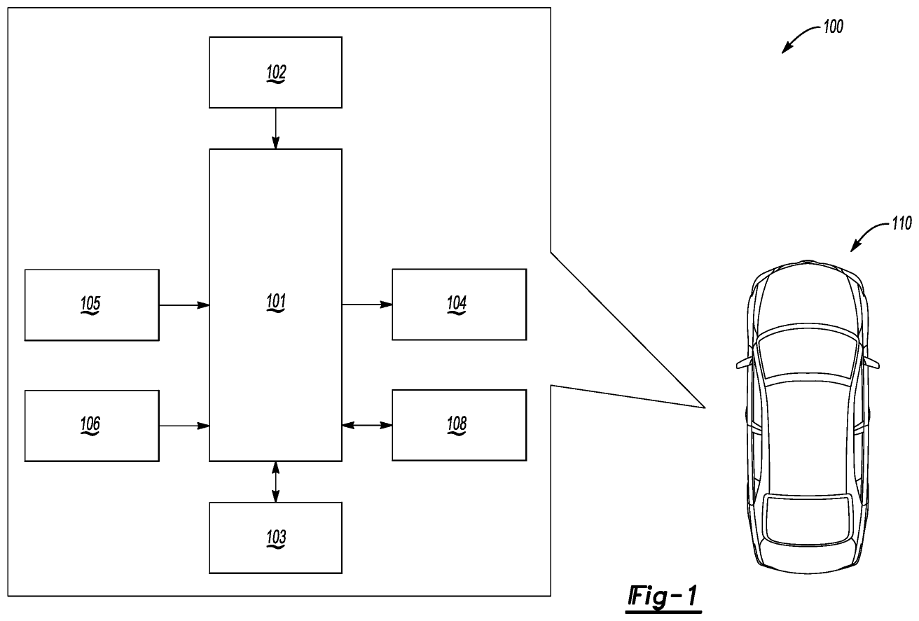

An apparatus and method that distribute driving resources will now be described in detail with reference to FIGS. 1-3 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or combined into one or more devices. In addition, individual elements may be provided on separate devices.

Vehicles such as passenger cars, motorcycles, trucks, sports utility vehicles (SUVs), recreational vehicles (RVs), marine vessels, aircraft, etc., are being equipped with communication devices capable of vehicle to vehicle communication and vehicle to infrastructure communication. The addition of these devices provides opportunities to provide new functionalities to drivers or occupants of autonomous vehicles. In particular, occupants or drivers of a host vehicle may want to request resources from another vehicle or share host vehicle resources with another vehicle. However, there needs to be a way to determine the availability of resources from target vehicles and a way to allocate resources especially when competition for requested resources exists.

One way to address the issue of a surplus or deficiency of driving resources in a host vehicle is to broadcast a request or bid for driving resources that a host vehicle or operator wants or needs or to broadcast a request for bids for a surplus driving resource of the host vehicle. In addition, when competing for driving resources, an auction style system may be used to allocate the driving resources. Further, such a system would enable various types of driving resources, which were previously not exchangeable, to be exchanged between vehicles in a manner not previously available to operators and occupants of vehicles.

FIG. 1 shows a block diagram of a system that distributes driving resources 100 according to an exemplary embodiment. As shown in FIG. 1, the system that distributes driving resources 100, according to an exemplary embodiment, includes a controller 101, a power supply 102, a storage 103, an output 104, sensors 105, and a communication device 108. However, the system that distributes driving resources 100 is not limited to the aforementioned configuration and may be configured to include additional elements and/or omit one or more of the aforementioned elements. The system that distributes driving resources 100 may be implemented as part of a vehicle or as a standalone component.

The controller 101 controls the overall operation and function of the system that distributes driving resources 100. The controller 101 may control one or more of a storage 103, an output 104, sensors 105, and a communication device 108 of the system that distributes driving resources 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, sensors 105, and the communication device 108 of the system that distributes driving resources 100. The information may be sent and received via a bus or network, or may be directly read or written to/from one or more of the storage 103, the output 104, sensors 105, and the communication device 108 of the system that distributes driving resources 100. Examples of suitable network connections include a controller area network (CAN), a media oriented system transfer (MOST), a local interconnection network (LIN), a local area network (LAN), and other appropriate connections such as Ethernet.

The power supply 102 provides power to one or more of the controller 101, the storage 103, the output 104, sensors 105, and the communication device 108 of the system that distributes driving resources 100. The power supply 102 may include one or more from among a battery, an outlet, a capacitor, a solar energy cell, a generator, a wind energy device, an alternator, etc.

The storage 103 is configured for storing information and retrieving information used by the system that distributes driving resources 100. The storage 103 may be controlled by the controller 101 to store and retrieve information such as one or more from among driving and situation resource information and occupant preference information. The storage 103 may also include the computer instructions configured to be executed by a processor to perform the functions of the system that distributes driving resources 100.

The driving and situation resource information may include, but is not limited to, one or more from among a route of the host vehicle, a lane of travel of the host vehicle, parking spots available to the host vehicle, a driving configuration of the host vehicle, an energy level of the host vehicle, a speed of the host vehicle, traffic light status, and traffic light timing. The occupant preference information may include one or more from among a preferred route to a destination of the host vehicle, a preferred lane to be traveled on by the host vehicle, a preferred, driving configuration of the host vehicle, a preferred parking spot for the host vehicle, a required energy level of the host vehicle, and a preferred speed for the host vehicle.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), nonvolatile memory, EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the system that distributes driving resources 100. The output 104 may include one or more from among a speaker, a display, a transparent display, a centrally-located display, a head up display, a windshield display, a haptic feedback device, a vibration device, a tactile feedback device, a tap-feedback device, a holographic display, an instrument light, an indicator light, etc. The output 104 may output a notification including one or more from among an audible notification, a light notification, and a display notification. The notification or output may include information regarding a driving resource being offered, acceptance of an offer, acceptance of a bid for an offered driving resource.

The sensors 105 are configured to provide information to the system that distributes driving resources 100. The sensors may include cameras, lidars, radars, ultrasonic sensor, vehicle speed sensors, vehicle system sensors, a battery charge level sensor, etc. The controller 101 may process the information provided by the sensors to determining the driving and situation resource information of the host vehicle.

The communication device 108 may be used by the system that distributes driving resources 100 to communicate with various types of external apparatuses according to various communication methods. The communication device 108 may be used to send/receive an offer for a driving resource, a bid for a driving resource, driving and situation resource information, occupant preferences to/from the controller 101 of the system that distributes driving resources 100.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee.

The controller 101 of the system that distributes driving resources 100 may also be configured to receive driving and situation resource information of a host vehicle, compare the received driving and situation resource information with occupant preference information to determine whether there is a deficiency of driving resources, a surplus of driving resources, or that the driving and situation resources meet the occupant preferences, offer a surplus resource to target vehicles if it is determined there is a surplus of driving resources; and make an offer for a resource corresponding to deficient resources of the host vehicle if it is determined there is a deficiency of driving resources. The occupant preference information may be that of a driver or an occupant in an autonomous vehicle

The controller 101 of the system that distributes driving resources 100 may be configured to offer the surplus resource to the target vehicles by controlling to broadcast a message including an offer to provide one or more from among a route of the host vehicle, a lane of travel of the host vehicle, parking spots available to the host vehicle, a driving configuration of the host vehicle, an energy level of the host vehicle, a speed of the host vehicle, and a price.

In the case that the offer includes an auction, the controller 101 of the system that distributes driving resources 100 may also be configured to receive bids for the offer from the target vehicles, select a bid from among the received bids, and transfer the offered surplus resource to a target vehicle corresponding to the selected bid from among the target vehicles.

The auction may include an electronic auction. The electronic auction may be one of a blind auction, Vickrey auction, a Vickrey-Clarke-Grove Auction, an English-style auction, or a Dutch-style auction. The auction may also include a reserve price.

The bids may include credits allocated to the host vehicle based on one or more from among resource sharing and driving habits. For example, the host vehicle may be allocated credits for sharing resources or according to driving habits. The driving habits may include speed of travel, attention to the road, or other driving maneuvers that are detectable by sensors and may be set to accrue positive credits by the system that distributes driving resources 100. According to one example, the credits may be in the form of a currency such as a government issued currency or an electronic currency.

The controller 101 of the system that distributes driving resources 100 may be further configured to transfer the surplus resource by controlling the host vehicle to provide the offered surplus resource to the target vehicle corresponding to the selected bid from among the target vehicles.

The controller 101 of the system that distributes driving resources 100 may be further configured to make an offer for the resource by determining whether the resource is being offered by analyzing communication messages from target vehicles or an infrastructure device, transmitting a bid for an offered resource if it is determined that the resource is being offered, and transmitting a bid requesting the resource if it is determined that the resource is not being offered.

The controller 101 of the system that distributes driving resources 100 may be further configured to determine if the bid for the resource is accepted, and control the vehicle to accept the transfer of the resource if it is determined that the bid is accepted.

The controller 101 of the system that distributes driving resources 100 may be further configured to control the vehicle by performing one or more from among changing the route of the host vehicle to a route corresponding to the transferred resource, changing the lane of travel of the host vehicle to a lane corresponding to the transferred resource, moving the host vehicle to a parking spot corresponding to the transferred resource, aligning the host vehicle with target vehicles in a driving configuration corresponding to the transferred resource, recharging the host vehicle with energy corresponding to the transferred resource, and increasing the speed of the host vehicle in manner corresponding to the transferred resource.

The changing the route of the host vehicle may include changing a route of a vehicle to pass over alternate roads such as private roads or toll roads. Further, the changing the lane of travel of the host vehicle may include switching to another lane on the same path or road that the host vehicle is traveling on. Further still, the aligning the host vehicle with target vehicles in a driving configuration may include an alignment with target vehicles that involves drafting.

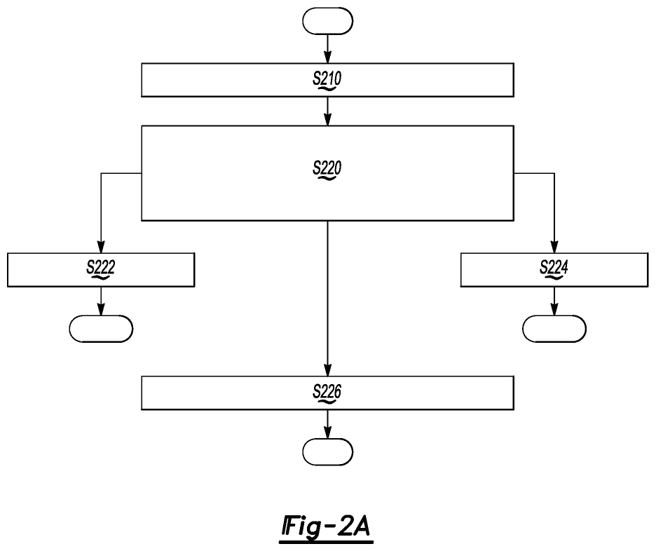

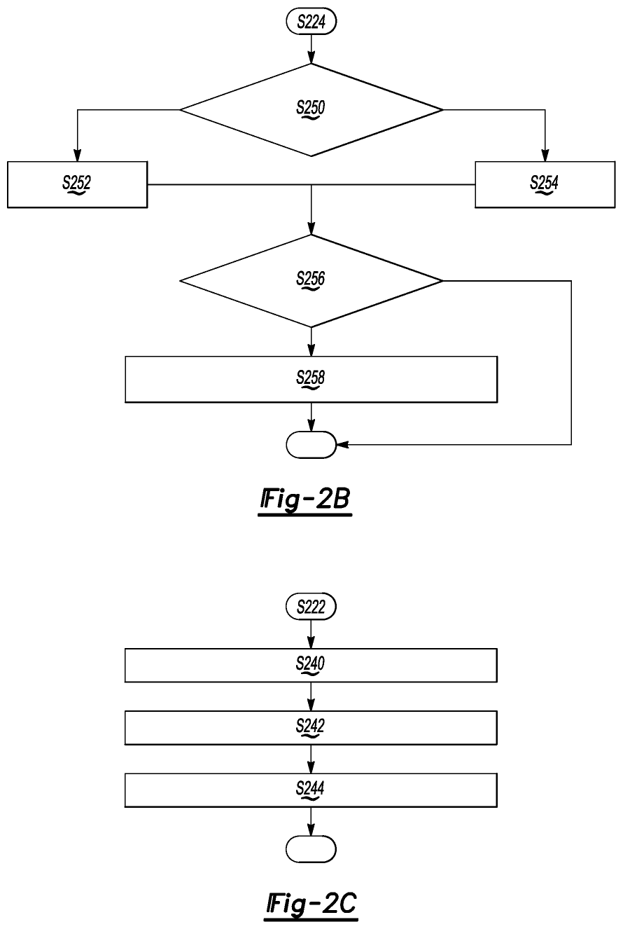

FIGS. 2A-2C show flowcharts for a method that distributes driving resources according to an exemplary embodiment. The method of FIG. 2 may be performed by the system that distributes driving resources 100 or may be encoded into a computer readable medium as instructions that are executable by a computer to perform the method.

Referring to FIG. 2A, driving situation and resource information is received in operation S210. In one example, information provided by sensors 105 or user input 106 may be analyzed to determine driving situation and resource information. The driving situation and resource information may be compared to occupant preference information to determine whether there is surplus driving of resources, there is deficiency of driving resources, or that driving situation and resources meet preferences in operation S220.

If there is there is surplus driving of resources in operation S222, the process moves to FIG. 2C for distributing surplus driving resources. If there is a deficiency of driving resources in operation S224, the process moves to FIG. 2B for requesting driving resources to address the deficiency. However, if the current driving situation or resources meet preferences of the occupant (operation S226), the process ends.

Referring to FIG. 2B, it is determined whether the deficient resource is being offered by another vehicle or infrastructure devices in operation S250. For example, the host vehicle may analyze messages being broadcast by target vehicles or infrastructure devices to determine what driving resources are being offered. If the deficient resource or another resource equested by the occupant is being offered (operations S250—Yes), the host vehicle or occupant may place a bid for the offered resource in operation S252. If the deficient resource or another esource requested by the occupant is not being offered (operations S250—No), the host vehicle or occupant may broadcast an offer or bid for deficient or requested resource in operation S254.

In operation S256, it is determined if the bid or offer is accepted. If the bid or offer is accepted in operation S256—Yes, then the host vehicle receives a notification of the transferred resource and is controlled to accept or use the transferred resource. For example, if a bid or offer for traveling in a lane is accepted, the host vehicle will be controlled to move to the lane and travel in the lane corresponding to the accepted offer. If the bid or offer is not accepted in operation S256—No, then the process ends.

Referring to FIG. 2C, a surplus resource may be selected and offered by the host vehicle or an occupant of the host vehicle in operation S240. In one example, the surplus resource may be auctioned to surrounding vehicles or their occupants. The winner of the surplus resource may be determined in operation 242. For example, the target vehicle or occupant with the largest auction bid or best bid may be determined as the winner of the surplus resource. Then, in operation S244, the offered surplus resource may be transferred to the winning target vehicle or occupant and credits corresponding to the bid from the winner may be transferred from the winning target vehicle or occupant to the host vehicle. For example, if the surplus resource is travel in a lane, the host vehicle may move to allow a target vehicle to enter into a lane. In another example, if the surplus resource is a battery charge, the host vehicle may be controlled to align and/or connect with the target vehicle to transfer battery charge.

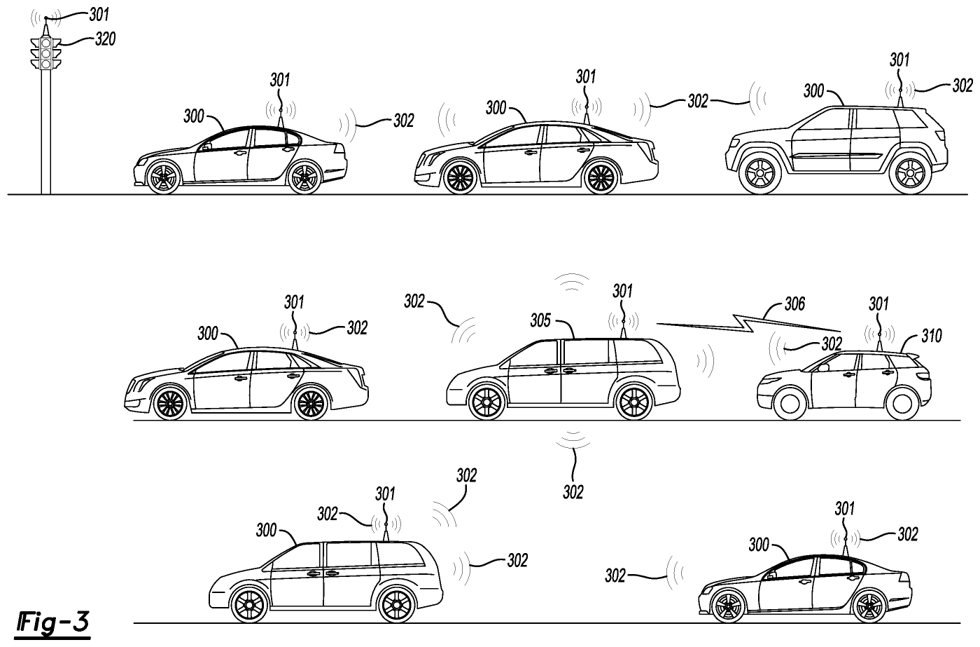

FIG. 3 shows an illustration of vehicle communicating to distribute driving resources according to an aspect of an exemplary embodiment.

Referring to FIG. 3, host vehicle 305 may be traveling along a road with many different target vehicles 300 and infrastructure devices 320. Each of the vehicles 300, host vehicle 305 and the infrastructure devices 320 may be equipped with elements of the system configured to distribute driving resources. For example, vehicles 300 and infrastructure devices 320 equipped with communication devices 301 capable of transmitting communication signals 302 to one another are shown in the illustration.

A host vehicle 305 may transmit an offer or receive an offer to/from one or more target vehicles 310 or infrastructure devices 320 (e.g., a traffic light). The host vehicle 305 may bid on or accept the received offer of the one or more target vehicles 310 or infrastructure devices 320. Alternatively, the one or more target vehicles 310 or infrastructure devices 320 may bid on or accept the offer of the host vehicle 305. Once an offer is accepted or a bid wins the offer, the host vehicle 305, the one or more target vehicles 310 or infrastructure devices 320 may operate or function to carry out the offer.

In this example, the traffic light may allow the host vehicle to pass by turning green when it is appropriate to do turn green or the target vehicles may allow the host vehicle to enter into their lane for faster travel. The host vehicle may be informed of a winning bid or accepted offer and may then be controlled to move into the faster lane or travel past the intersection once the light turns green.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for distributing driving resources, the method comprising:
receiving driving and situation resource information of a host vehicle;
comparing the received driving and situation resource information with occupant preference information to determine whether there is a deficiency of driving resources, a surplus of driving resources, or that the driving and situation resources meet the occupant preferences;
offering a surplus resource to target vehicles if it is determined there is a surplus of driving resources; and
making an offer for a resource corresponding to deficient resources of the host vehicle if it is determined there is a deficiency of driving resources.

2. The method of claim 1, wherein the driving and situation resource information comprises one or more from among a route of the host vehicle, a lane of travel of the host vehicle, parking spots available to the host vehicle, a driving configuration of the host vehicle, an energy level of the host vehicle, a speed of the host vehicle, traffic light status, traffic light timing.

3. The method of claim 1, wherein the occupant preference information is that of a driver or an occupant in an autonomous vehicle, and
wherein the occupant preference information comprises one or more from among a preferred route to a destination of the host vehicle, a preferred lane to be traveled on by the host vehicle, a preferred, driving configuration of the host vehicle, a preferred parking spot for the host vehicle, a required energy level of the host vehicle, and a preferred speed for the host vehicle.

4. The method of claim 3, wherein the offering the surplus resource to the target vehicles comprises broadcasting a message including an offer to provide one or more from among a route of the host vehicle, a lane of travel of the host vehicle, parking spots available to the host vehicle, a driving configuration of the host vehicle, an energy level of the host vehicle, a speed of the host vehicle, and a price.

5. The method of claim 4, wherein the offer comprises an auction, the method further comprising receiving bids for the offer from the target vehicles, selecting a bid from among the received bids, and transferring the offered surplus resource to a target vehicle corresponding to the selected bid from among the target vehicles.

6. The method of claim 5, wherein the transferring the surplus resource comprises controlling the host vehicle to provide the offered surplus resource to the target vehicle corresponding to the selected bid from among the target vehicles.

7. The method of claim 1, wherein the making an offer for the resource comprises determining whether the resource is being offered by analyzing communication messages from target vehicles or an infrastructure device, transmitting a bid for an offered resource if it is determined that the resource is being offered, and transmitting a bid requesting the resource if it is determined that the resource is not being offered.

8. The method of claim 7, further comprising determining if the bid for the resource is accepted, and controlling the vehicle to accept the transfer of the resource if it is determined that the bid is accepted.

9. The method of claim 8, wherein the controlling the vehicle comprises one or more from among changing the route of the host vehicle to a route corresponding to the transferred resource, changing the lane of travel of the host vehicle to a lane corresponding to the transferred resource, moving the host vehicle to a parking spot corresponding to the transferred resource, aligning the host vehicle with target vehicles in a driving configuration corresponding to the transferred resource, recharging the host vehicle with energy corresponding to the transferred resource, and increasing the speed of the host vehicle in manner corresponding to the transferred resource.

10. The method of claim 7, wherein the bid comprises credits allocated to the host vehicle based on one or more from among resource sharing and driving habits.

11. A system that distributes driving resources, the system comprising:
at least one memory comprising computer executable instructions; and
at least one processor configured to read and execute the computer executable instructions, the computer executable instructions causing the at least one processor to:
receive driving and situation resource information of a host vehicle;
compare the received driving and situation resource information with occupant preference information to determine whether there is a deficiency of driving resources, a surplus of driving resources, or that the driving and situation resources meet the occupant preferences;
offer a surplus resource to target vehicles if it is determined there is a surplus of driving resources; and
make an offer for a resource corresponding to deficient resources of the host vehicle if it is determined there is a deficiency of driving resources.

12. The system of claim 11, wherein the driving and situation resource information comprises one or more from among a route of the host vehicle, a lane of travel of the host vehicle, parking spots available to the host vehicle, a driving configuration of the host vehicle, an energy level of the host vehicle, and a speed of the host vehicle.

13. The system of claim 11, wherein the occupant preference information is that of a driver or an occupant in an autonomous vehicle, and
wherein the occupant preference information comprises one or more from among a preferred route to a destination of the host vehicle, a preferred lane to be traveled on by the host vehicle, a preferred, driving configuration of the host vehicle, a preferred parking spot for the host vehicle, a required energy level of the host vehicle, and a preferred speed for the host vehicle.

14. The system of claim 13, wherein the computer executable instructions further cause the at least one processor to offer the surplus resource to the target vehicles by broadcasting a message including an offer to provide one or more from among a route of the host vehicle, a lane of travel of the host vehicle, parking spots available to the host vehicle, a driving configuration of the host vehicle, an energy level of the host vehicle, a speed of the host vehicle, and a price.

15. The system of claim 14, wherein the offer comprises an auction, and
wherein the computer executable instructions further cause the at least one processor to receive bids for the offer from the target vehicles, select a bid from among the received bids, and transfer the offered surplus resource to a target vehicle corresponding to the selected bid from among the target vehicles.

16. The system of claim 15, wherein the computer executable instructions further cause the at least one processor to transfer the surplus resource by controlling the host vehicle to provide the offered surplus resource to the target vehicle corresponding to the selected bid from among the target vehicles.

17. The system of claim 11, wherein the computer executable instructions further cause the at least one processor to make an offer for the resource by determining whether the resource is being offered by analyzing communication messages from target vehicles or an infrastructure device, transmitting a bid for an offered resource if it is determined that the resource is being offered, and transmitting a bid requesting the resource if it is determined that the resource is not being offered.

18. The system of claim 11, wherein the computer executable instructions further cause the at least one processor to determine if the bid for the resource is accepted, and control the vehicle to accept the transfer of the resource if it is determined that the bid is accepted.

19. The system of claim 18, wherein the computer executable instructions further cause the at least one processor to control the vehicle by performing one or more from among changing the route of the host vehicle to a lane corresponding to the transferred resource, changing the lane of travel of the host vehicle to a lane corresponding to the transferred resource, moving the host vehicle to a parking spot corresponding to the transferred resource, aligning the host vehicle with target vehicles in a driving configuration corresponding to the transferred resource, recharging the host vehicle with energy corresponding to the transferred resource, and increasing the speed of the host vehicle in manner corresponding to the transferred resource.

20. The system of claim 17, wherein the bid comprises credits allocated to the host vehicle based on one or more from among resource sharing and driving habits.
